(19) United States
(12) Patent Application Publication
(10) Pub. No.: US 2017/0103717 A1
(43) Pub. Date: Apr. 13, 2017

(54) ELECTRONIC DEVICE AND APPEARANCE MODULE THEREOF

(71) Applicant: Acer Incorporated, New Taipei City (TW)

(72) Inventor: Jin-Ting KUO, New Taipei City (TW)

(21) Appl. No.: 15/089,245

(22) Filed: Apr. 1, 2016

(30) Foreign Application Priority Data
Oct. 7, 2015 (TW) 104132977

(51) Int. Cl. G09G 3/36; G09G 3/20

(52) U.S. Cl. CPC G09G 3/36; G09G 3/2092

(57) ABSTRACT

An electronic device is provided. A member includes a first surface. A first hole and a second hole are in the first surface. A film includes a first electrode, a second electrode, a third electrode, and a liquid-crystal layer. The liquid-crystal layer includes a first region located between the first and third electrodes and a second region located between the second and third electrodes. The first electrode corresponds to the first hole. The second electrode corresponds to the second hole. A driving chip controls voltage levels of the first, second and third electrodes so that first light passes through the first hole or second light passes through the second hole. A display panel is configured to display a plurality of images. A host unit controls the display panel to display the images. The host unit controls the driving chip.

### CROSS REFERENCE TO RELATED APPLICATIONS

This application claims priority of Taiwan Patent Application No. 104132977, filed on Oct. 7, 2015, the entirety of which is incorporated by reference herein.

### BACKGROUND OF THE INVENTION

Field of the Invention

The invention relates to an electronic device, and more particularly to an electronic device with a case which comprises various holes.

Description of the Related Art

As technology develops, there are an increasing number of types of electronic devices. Generally, these electronic devices comprise mobile electronic devices and non-mobile electronic devices. However, the cases that cover each mobile and non-mobile electronic device are usually distinguished by being only one solid color, or else they may sport a decorative yet static form or pattern. Therefore, these cases cannot provide a dynamic visual effect.

### BRIEF SUMMARY OF THE INVENTION

In accordance with an embodiment, an electronic device comprises a member, a film, a driving chip, a display panel, and a host unit. The member comprises a first surface. There is a first hole and a second hole in the first surface. The film comprises a first electrode, a second electrode, a third electrode, and a liquid-crystal layer. The liquid-crystal layer comprises a first region and a second region. The first region is located between the first and third electrodes. The second region is located between the second and third electrodes. The first electrode corresponds to the first hole. The second electrode corresponds to the second hole. The driving chip controls voltage levels of the first, second and third electrodes so that first light passes through the first hole or second light passes through the second hole. The display panel is configured to display a plurality of images. The host unit controls the display panel to display the images and controls the driving chip.

In accordance with another embodiment, an appearance module comprises a member, a film, a display panel, and a driving chip. The member comprises a first surface and a second surface. The first surface comprises a first hole and a second hole. The film comprises a first electrode, a second electrode, a third electrode, and a liquid-crystal layer. The liquid-crystal layer comprises a first region and a second region. The first region is located between the first and third electrodes. The second region is located between the second and third electrodes. The first electrode corresponds to the first hole. The second electrode corresponds to the second hole. The display panel is disposed on the second surface to display a plurality of images. The driving chip controls voltage levels of the first, second, and third electrodes to control first light to pass through the first hole or control second light to pass through the second hole. The driving chip controls the display panel to display the images.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1A is a schematic diagram of an electronic device, in accordance with an embodiment of the invention;

FIG. 1B is a schematic diagram of the A-cover 110, in accordance with an embodiment of the invention;

FIG. 2 is a schematic diagram of the first member 110, in accordance with an embodiment of the invention;

FIGS. 3A-3D are schematic diagrams of the A-cover 111, in accordance with some embodiments; and

FIG. 4 is a control schematic diagram of electrodes, in accordance with an embodiment of the invention.

### DETAILED DESCRIPTION OF THE INVENTION

The making and using of the embodiments of the disclosure are discussed in detail below. It should be appreciated, however, that the embodiments provide many applicable inventive concepts that can be embodied in a wide variety of specific contexts. The specific embodiments discussed are merely illustrative, and do not limit the scope of the disclosure.

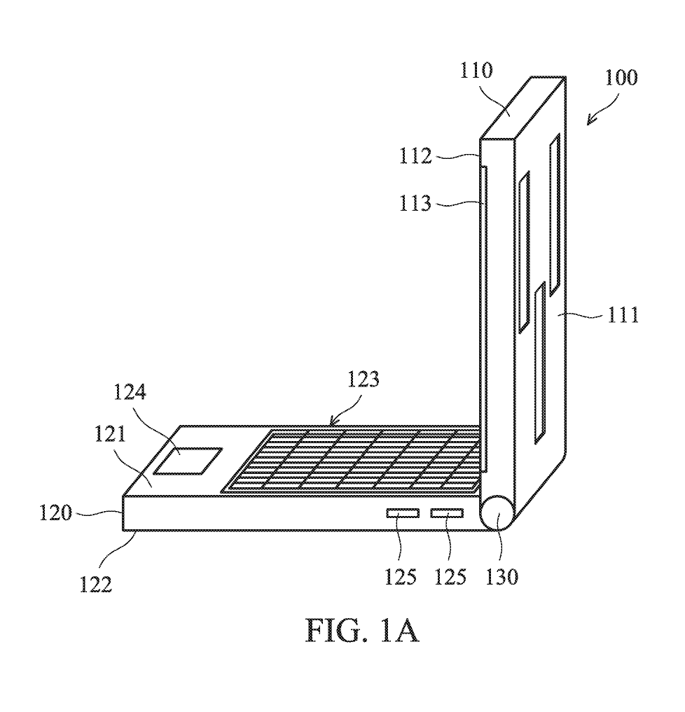

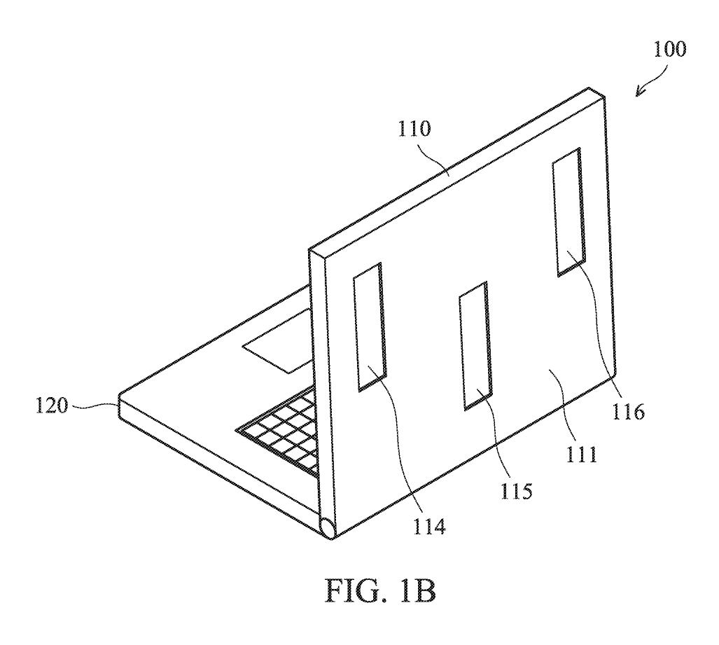

FIG. 1A is a schematic diagram of an electronic device, in accordance with an embodiment of the invention. The electronic device 100 is a laptop computer and comprises a first member 110, a second member 120 and a rotational member 130. The first member 110 is also referred to as an appearance module. As shown in FIG. 1, the first member 110 comprises an A-cover 111 and a B-cover 112. FIG. 1B is a schematic diagram of the A-cover 110, in accordance with an embodiment of the invention. As shown in FIG. 1B, the surface of the A-cover 111 comprises holes 114˜116, however, without limitation to the present invention. In other embodiments, the A-cover 111 may comprise any suitable number of holes. In this present invention, the number, shape and size of the holes is not limited. The shape and the area of one of the holes 114˜116 may be the same as or different from the shape and the area of another of the holes 114˜116.

Refer to FIG. 1A, a display panel 113 is inserted into the B-cover 112. A user can utilize the input interface, such as a keyboard 123 or a touch plate 124, of the second member 120 to launch a corresponding application program or process data according to the image displayed on the display panel 113. In one embodiment, the display panel 113 has a touch function. The user can utilize fingers to touch the display panel 113 to select the icon displayed on the display panel 113.

The second member 120 comprises a C-cover 121 and a D-cover 122. The keyboard 123 and the touch plate 124 are disposed in the C-cover 121. The user is capable of utilizing the keyboard 123 and the touch plate 124 to control the images displayed on the display panel 113. In other embodiments, the second member 120 further comprises a plurality of transmission interfaces 125 configured to connect to external devices, such as a mouse, a CD player or flash drive.

The second member 120 further comprises a host unit (not shown). The host unit controls the images displayed by the display panel 113 according to input information received by the input interfaces (e.g. 123 and 124) or the transmission interface 125. In the present invention, the circuit structure of host unit is not limited. In one embodiment, the host unit comprises various micro-processors, various micro-controller, various memories, various logic circuits to process data.

The rotational member 130 is disposed between the first member 110 and the second member 120 to connect the first member 110 and the second member 120. In some embodiments, the second member 120 and the rotational member 130 can be omitted. In this case, the electronic elements in the second member 120 are integrated into the first member 110. For example, the electronic device 100 can be a mobile electronic device, such as a smartphone. When the electronic device 100 is a smartphone, the holes 114˜116 are located on the back-plate of the smartphone. In other embodiments, the electronic device 100 is a desktop computer. In this case, the holes 114˜116 are located on the case of the desktop computer.

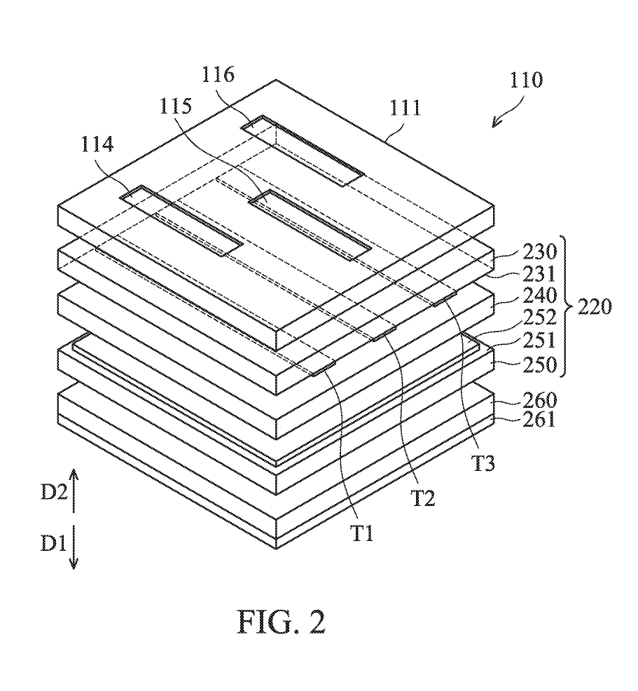

FIG. 2 is a schematic diagram of the first member 110, in accordance with an embodiment of the invention. As shown in FIG. 2, the first member 110 at least comprises the A-cover 111, a film 220 and a display panel 260, but the disclosure is not limited thereto. In other embodiments, the first member 110 does not comprise the display panel 260.

The A-cover 111 comprises holes 114˜116. The A-cover 111 may comprise any suitable number of holes. Each of the holes 114˜116 may comprise any suitable shape. The film 220 is disposed under the A-cover 111 to determine that light passes through which hole. As shown in FIG. 2, the film 220 comprises conductive layers 230 and 250 and a liquid-crystal layer 240.

The conductive layer 230 is a film which is transparent and comprises conductive material. In this embodiment, the bottom surface of the conductive layer 230 comprises electrodes T1˜T3, but the disclosure is not limited thereto. In some embodiments, the conductive layer 230 may comprise any suitable number of electrodes. The electrodes T1˜T3 are independently disposed and are insulated from each other. In one embodiment, the electrodes T1˜T3 are long bars and meshed conductors. The mapping positions of the electrodes T1˜T3 in the direction D2 correspond to the holes 114˜116, respectively. As shown in FIG. 2, the electrode T1 corresponds to the hole 114, the electrode T2 corresponds to the hole 115, and the electrode T3 corresponds to the hole 116, but the disclosure is not limited thereto. In some embodiments, an electrode corresponds to many holes, or many electrode corresponds to a single hole. In this embodiment, the electrodes T1˜T3 are long bars, however, without limitation to the present invention. In other embodiments, the shapes of the electrodes T1˜T3 can be any suitable shapes.

The conductive layer 250 is a transparent film comprising conductive materials. The top-surface of the conductive layer 250 comprises an electrode 252. The electrode 252 has a mapping position in the direction D2, wherein the electrodes T1˜T3 cover the mapping position. In this embodiment, the electrode 252 covers the greater part of the top-surface 251 of the conductive layer 250. The electrode 252 receives a voltage level, such as a ground level, but the disclosure is not limited thereto. In other embodiments, the electrode 252 receives a positive voltage or a negative voltage.

In the present invention, the materials of the electrodes T1˜T3 and 252 are not limited. In one embodiment, the materials of the electrodes T1˜T3 and 252 are Silver Nano wires, Indium Tin Oxides (ITOs), Carbon Nano tubes (CNTs) or Poly-3,4-Ethylenedioxythiophenes (PEDOTs).

The liquid-crystal layer 240 is disposed between the conductive layers 230 and 250. The invention does not limit the kind of liquid-crystal layer 240. In one embodiment, the liquid-crystal layer 240 comprises a Polymer-dispersed Liquid-crystal (PDLC) material or a Cholesteric Liquid-crystal (CHLC) material. In this embodiment, the liquid-crystal layer 240 is divided into three regions, wherein a first region is disposed between the electrodes T1 and 252, a second region is disposed between the electrodes T2 and 252, and a third region is disposed between the electrodes T3 and 252. The voltage levels of the electrodes T1˜T3 and 252 can change the arrangements of the liquid-crystal components in the first to third regions so that the liquid-crystal component in the corresponding region is switched to a transparent phase or an opaque phase.

Since the control methods for the electrodes T1˜T3 are the same, the control method of the electrode T1 is given as an example. For example, when the voltage difference between the electrodes T1 and 252 is greater than a pre-determined value, the liquid-crystal component in the first region disposed between the electrodes T1 and 252 is in a transparent phase. Therefore, light is capable of passing through the first region of the liquid-crystal layer 240 and passing through the electrode T1 and the hole 114. However, when the voltage difference between the electrodes T1 and 252 is not greater than the pre-determined value, the liquid-crystal component in the first region disposed between the electrodes T1 and 252 is in an opaque phase. Therefore, no light passes through the electrode T1 and the hole 114. In this embodiment, the voltage levels of the electrodes T1˜T3 and 252 are controlled so that the light can pass through the corresponding electrode and hole. In one embodiment, the liquid-crystal components in the first, second and third regions of the liquid-crystal layer 240 are switched in the transparent phase in order.

In one embodiment, when the voltage level of the electrode T1 is equal to the voltage level of the electrode 252, the liquid-crystal component in the first region is switched to an opaque phase. When the voltage level of the electrode T1 is unequal to the voltage level of the electrode 252, the liquid-crystal component in the first region is switched to a transparent phase. In one embodiment, when the voltage difference between the electrodes T1 and 252 is within 15V˜20V, the liquid-crystal component in the first region is switched to the transparent phase.

In the present invention, the shapes of the conductive layers 230 and 250 are not limited. In some embodiments, the bottom-surface 231 of the conductive layer 230 only comprises an entire electrode similar to the electrode 252, and the top-surface 251 of the conductive layer 250 comprises a plurality of electrodes insulated from each other and similar to the electrodes T1˜T3. In this case, the entire electrode of the conductive layer 230 receives a fixed voltage level, such as a ground level. In this embodiment, the divided regions are defined by the plurality of electrodes on the top-surface 251 of the conductive layer 250. For example, each region of the liquid-crystal layer 240 covers a corresponding electrode.

In other embodiments, the conductive layers 230 and 250 comprise a plurality of electrodes insulated from each other, respectively. In this case, each electrode of the conductive layer 230 covers a specific electrode of the conductive layer 250. In some embodiments, the number of the electrodes of the conductive layer 250 is less than or equal to the number of the electrodes of the conductive layer 230.

The display panel 260 is disposed under the conductive layer 250. In this embodiment, the display panel 260 comprises a touch panel 261, but the disclosure is not limited thereto. In other embodiments, the display panel 260 does not have a touch function. Additionally, the touch panel 261 may be integrated into the display panel 260 or attached on the surface of the display panel 260 to provide a touch function.

In one embodiment, the display panel 260 comprises a driving chip (not shown). The driving chip controls the display panel 260 to display the corresponding image according to a control signal generated by a host unit disposed in the second member 120. The driving chip may be disposed in the second member 120. The driving chip detects the touched position of the touch panel 261 and provides the detection result to the host unit disposed in the second member 120. In this embodiment, the voltage levels of the electrodes T1˜T3 and 252 are controlled by the driving chip. Therefore, no extra element is increased.

In other embodiments, the first member 110 further comprises a backlight module to emit light. In the present invention, the type of backlight module is not limited. For example, the backlight module is an edge lighting backlight module or a bottom lighting backlight module. When the liquid-crystal component in the first region of the liquid-crystal layer 240 is switched to the transparent phase, the light emitted from the backlight module (not shown) can pass through the film 220 and the hole 114. When the liquid-crystal component in the first region of the liquid-crystal layer 240 is switched to the opaque phase, the light cannot pass through the hole 114. In the present invention, the position of the backlight module is not limited. In one embodiment, the backlight module is disposed in the display panel 260 and emits the light in directions D1 and D2.

To increase the intensity of the light, a light guide layer (not shown) is disposed between the display panel 260 and the conductive layer 250 to guide the lights emitted from the backlight module to pass through the film 220 in other embodiments. In one embodiment, each of the lights passing through the holes 114˜116 is white light, however, without limitation to the present invention. In other embodiments, the color of one of the lights passing through the holes 114˜116 may be the same as or different from the color of another of the lights passing through the holes 114˜116. Furthermore, the color of the light passing through the film 220 may be the same as or different from the color of the light passing through the hole 114. For example, the color of the light passing through the film 220 may be white, and the color of the light passing through the hole 1140 may be red, but the disclosure is not limited thereto. In some embodiments, the color of the light passing through the film 220 may be the same as the color of the light passing through the hole 114.

To control the colors of the lights passing through the holes 114˜116, a color layer (not shown) is disposed in the first member 110 in one embodiment. In the present invention, the position of the color layer is not limited. The color layer can be disposed in any position, as long as the color layer is capable of controlling the colors of the lights passing through the holes 114˜116. For example, the color layer can be disposed between the hole 114 and the film 220, disposed in the film 220, or disposed between the conductive layer 250 and the display panel 260. In some embodiments, the liquid-crystal components in the liquid-crystal layer 240 has colors. Therefore, the lights passing through the film 220 have colors. In another embodiment, a reflection layer is disposed under the conductive layer 250 to reflect the light with color.

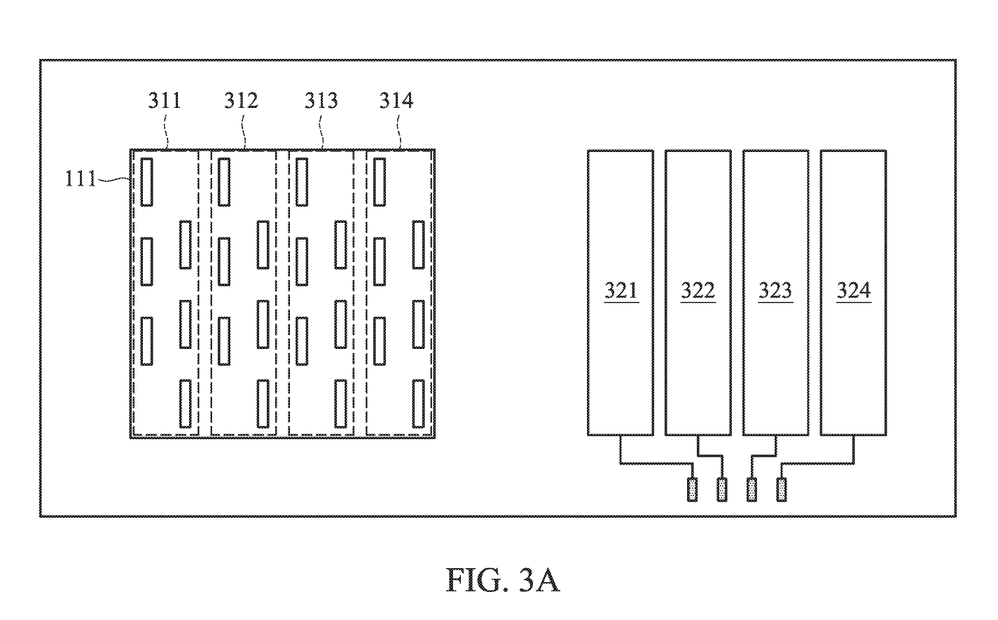

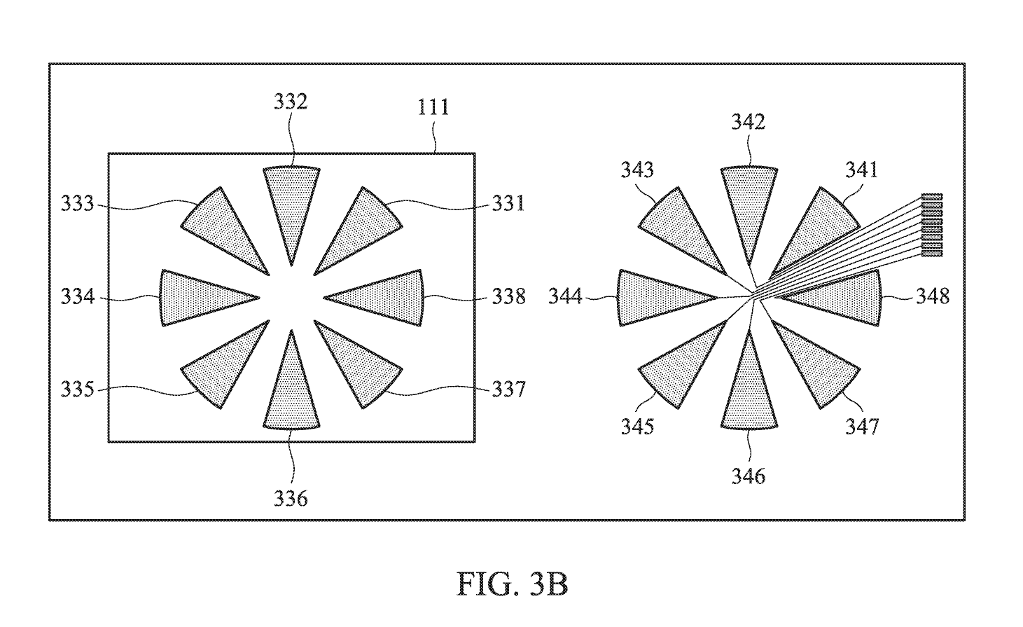

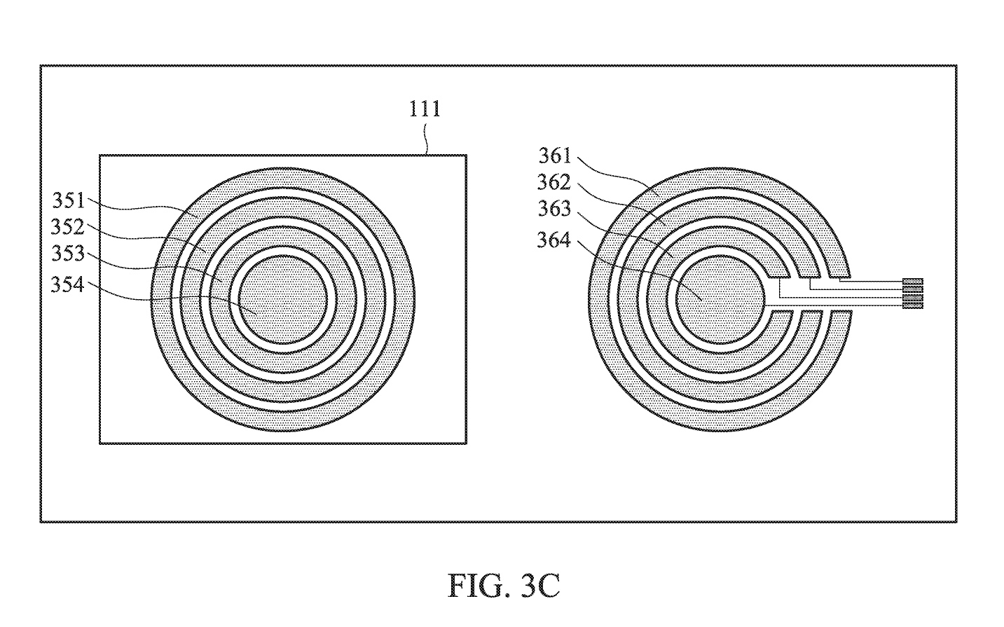

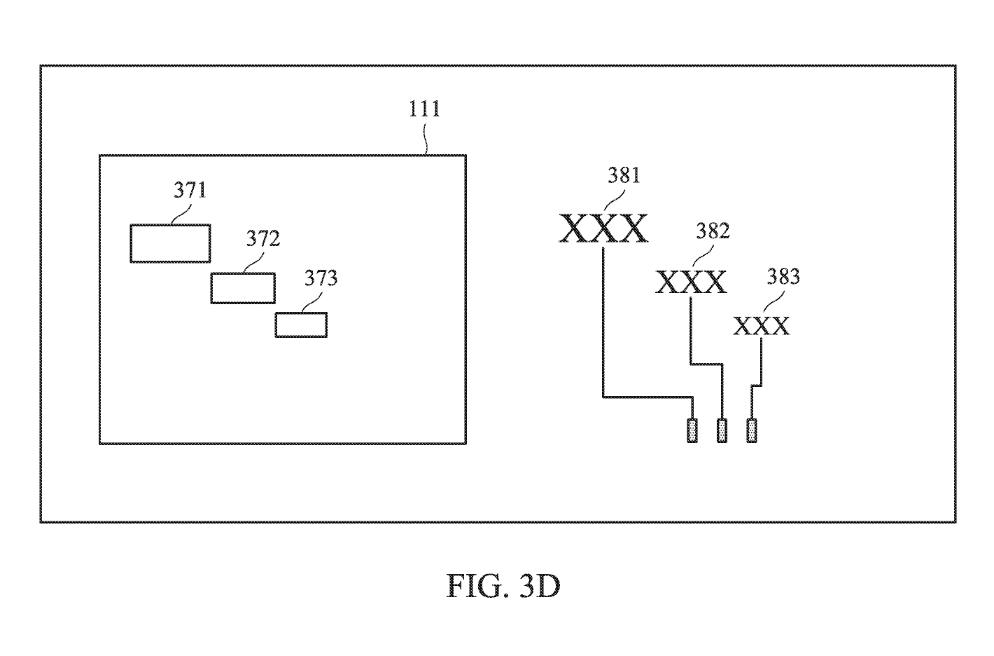

FIGS. 3A˜3D are schematic diagrams of the A-cover 111, in accordance with some embodiments. Referring to FIG. 3A, the A-cover 111 comprises hole units 311˜314. Each hole unit comprises a plurality of holes. The hole units are long bars. The arrangement of the hole units are interlaced. Each hole unit covers a corresponding electrode. For example, the hole unit 311 covers the electrode 321, and the hole unit 312 covers the electrode 322. The voltage levels of the electrodes 321˜324 are controlled to switch the liquid-crystal component in the corresponding region of the liquid-crystal layer to a transparent phase or an opaque phase. For example, when the region covered by the electrode 321 is switched to the transparent phase, the light can pass through the liquid-crystal layer and the hole unit 311. In one embodiment, the liquid-crystal components in the various regions of the liquid-crystal layer are switched to the transparent phase in order. Therefore, the A-cover 111 is capable of displaying dynamic effects.

In FIG. 3B, the A-cover 111 comprises holes 331338. The holes 331338 form a radioactive pattern. Similarly, the electrodes 341˜348 also form a radioactive pattern. Each electrode corresponds to a hole and covers a specific region of the liquid-crystal layer. In one embodiment, the liquid-crystal components of the regions of the liquid-crystal layer are switched to the transparent phase sequentially.

In FIG. 3C, the A-cover 111 comprises holes 351˜354. In this embodiment, each of the holes 351˜353 is a ringed pattern and the hole 354 is a circle. The electrodes 361˜364 correspond to the holes 351˜354 respectively. The voltage levels of the electrodes 361˜364 are controlled so that the lights pass through the holes 351˜354 in order.

In FIG. 3D, the A-cover 111 comprises holes 371˜373. The area of the hole 371 is greater than the area of the hole 372. The area of the hole 372 is greater than the area of the hole 373. In this embodiment, the electrodes 381˜383 are text patterns, such as XXX. The pattern of the electrode 381 is greater than the pattern of the electrode 382. The pattern of the electrode 382 is greater than the pattern of the electrode 383.

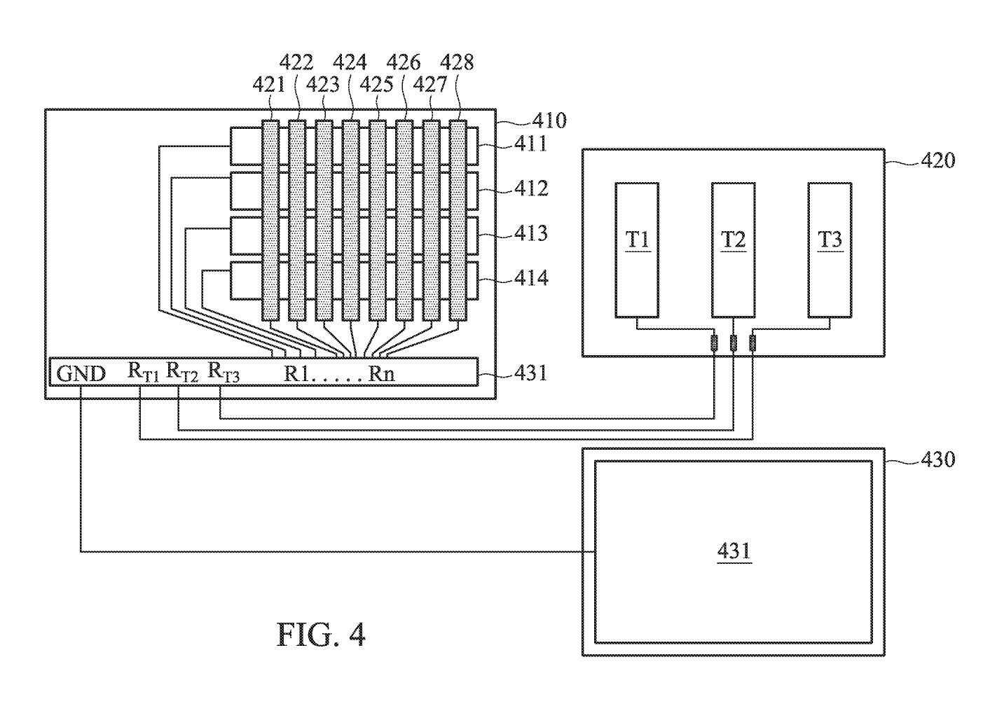

FIG. 4 is a control schematic diagram of electrodes, in accordance with an embodiment of the invention. For clarity, FIG. 4 only shows a touch panel 410, conductive layers 420 and 430. The touch panel 410 corresponds to the touch panel 261 shown in FIG. 2. The conductive layers 420 corresponds to the conductive layer 230 shown in FIG. 2, and the conductive layer 430 corresponds to the conductive layer 250 shown in FIG. 2, however, without limitation to the present invention. In other embodiments, the conductive layers 420 and 430 correspond to the conductive layers 250 and 230 shown in FIG. 2, respectively.

As shown in FIG. 4, the touch panel 410 comprises a driving chip 431. The driving chip 430 provides sensing signals to the electrodes 411˜414 and reads the voltage levels of the electrodes 421˜428 to determine whether the touch panel 410 is touched and the touched position. In other embodiments, the driving chip 431 also controls the display panel, such as 113. In this case, the driving chip 431 controls the images displayed on the display panel according to a host unit.

In this embodiment, the driving chip 431 further controls the voltage levels of the electrodes T1˜T3 and 431. For clarity, in the liquid-crystal layer, the region covered by the electrode T1 is referred to as a first region, the region covered by the electrode T2 is referred to as a second region, and the region covered by the electrode T3 is referred to as a third region. A host unit utilizes the driving chip 431 to control the liquid-crystal components in the first to third regions so that each of the liquid-crystal components in the first to third regions is switched in a transparent phase or an opaque phase. In this embodiment, the driving chip 431 provides a ground level GND to the electrode 431 and controls the voltage levels of the electrodes T1˜T3.

Since the driving chip 431 controlling the voltage levels of the electrodes T1˜T3 and 431 is utilized, no extra element is increased. Furthermore, the shapes and number of the electrodes T1˜T3 are suitably controlled so that the A-cover 111 has a dynamic visual effect.

Unless otherwise defined, all terms (including technical and scientific terms) used herein have the same meaning as commonly understood by one of ordinary skill in the art to which this invention belongs. It should be further understood that terms such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a member comprising a first surface, wherein a first hole and a second hole are in the first surface;
a film comprising a first electrode, a second electrode, a third electrode, and a liquid-crystal layer, wherein the liquid-crystal layer comprises a first region and a second region, the first region is located between the first and third electrodes, the second region is located between the second and third electrodes, the first electrode corresponds to the first hole, and the second electrode corresponds to the second hole;
a driving chip controlling voltage levels of the first, second and third electrodes to allow first light to pass through the first hole or allow second light to pass through the second hole;
a display panel configured to display a plurality of images; and
a host unit controlling the display panel to display the images and controlling the driving chip.

2. The electronic device as claimed in claim 1, wherein the member further comprises a second surface, the display panel is disposed on the second surface, and the host unit utilizes the driving chip to control the display panel.

3. The electronic device as claimed in claim 1, wherein at least one of the first, second, and third electrodes is a meshed conductor, a Silver Nano wire, an Indium Tin Oxide (ITO), a Carbon Nano tube (CNT) or a Poly-3,4-Ethylenedioxythiophene (PEDOT).

4. The electronic device as claimed in claim 1, wherein when a voltage difference between the first and third electrodes is greater than a pre-determined value, the first region is transparent so that the first light passes through the first hole, and when the voltage difference between the first and third electrodes is not greater than the pre-determined value, the first region is opaque so that the first light does no pass through the first hole.

5. The electronic device as claimed in claim 4, wherein the driving chip provides a ground level to the third electrode.

6. The electronic device as claimed in claim 4, wherein when the voltage level of the first electrode is equal to the voltage level of the third electrode, the first region is opaque.

7. The electronic device as claimed in claim 1, wherein the film further comprises a light guide layer configured to guide the first light passing through the first region or guide the second light passing through the second region.

8. The electronic device as claimed in claim 1, wherein when the first light passes through the first hole, the first hole displays first displayed light, when the second light passes through the second hole, the second hole displays second displayed light, the first displayed light has a first color, and the second displayed light has a second color different from the first color.

9. The electronic device as claimed in claim 8, further comprising:
a color layer configured to generate the first displayed light and the second displayed light.

10. The electronic device as claimed in claim 9, wherein the color layer is disposed between the first hole and the first electrode, and a color of the first light is different from the first color.

11. The electronic device as claimed in claim 9, wherein the color layer is integrated into the film.

12. The electronic device as claimed in claim 1, wherein the liquid-crystal layer has a Polymer-dispersed Liquid-crystal (PDLC) material or a Cholesteric Liquid-crystal material.

13. The electronic device as claimed in claim 1, wherein the driving chip controls the first and second region to be transparent sequentially so that the first and second lights sequentially pass through the first and second holes, respectively.

14. The electronic device as claimed in claim 1, wherein the first surface further comprises a third hole corresponding to the first electrode.

15. The electronic device as claimed in claim 1, wherein an area of the first hole is different from an area of the second hole.

16. An appearance module comprising:
a member comprising a first surface and a second surface, wherein the first surface comprises a first hole and a second hole;
a film comprising a first electrode, a second electrode, a third electrode, and a liquid-crystal layer, wherein the liquid-crystal layer comprises a first region and a second region, the first region is located between the first and third electrodes, the second region is located between the second and third electrodes, the first electrode corresponds to the first hole, and the second electrode corresponds to the second hole;
a display panel disposed on the second surface to display a plurality of images; and
a driving chip controlling voltage levels of the first, second, and third electrodes to control first light to pass through the first hole or control second light to pass through the second hole, wherein the driving chip controls the display panel to display the images.

17. The appearance module as claimed in claim 16, wherein the first surface further comprises a third hole corresponding to the first hole.

18. The appearance module as claimed in claim 16, wherein when a voltage difference between the first and third electrodes is greater than a pre-determined value, the first region is transparent so that the first light passes through the first hole, and when the voltage difference between the first and third electrodes is not greater than the pre-determined value, the first region is opaque so that the first light does not pass through the first hole.

19. The appearance module as claimed in claim 16, wherein the liquid-crystal layer has a Polymer-dispersed Liquid-crystal (PDLC) material or a Cholesteric Liquid-crystal material.

20. The appearance module as claimed in claim 16, wherein the first and second lights sequentially pass through the first and second holes, respectively.
